(19) United States
(12) Patent Application Publication
(10) Pub. No.: US 2014/0292780 A1
(43) Pub. Date: Oct. 2, 2014

(54) Automatically Configurable Video Systems with Multiple Sources and Method of Configuring Video Systems

(71) Applicants: Mark J. Jedrzejewski, Loveland, CO (US); Courtney D. Goeltzenleuchter, Fort Collins, CO (US)

(72) Inventors: Mark J. Jedrzejewski, Loveland, CO (US); Courtney D. Goeltzenleuchter, Fort Collins, CO (US)

(73) Assignee: HEWLETT-PACKARD DEVELOPMENT COMPANY, L.P., Houston, TX (US)

(21) Appl. No.: 14/350,915

(22) PCT Filed: Oct. 27, 2011
(86) PCT No.: PCT/US2011/058083

§ 371 Date: Apr. 10, 2014

(51) Int. Cl. G09G 5/00; G06F 3/14

(52) U.S. Cl. CPC G09G 5/003; G06F 3/14; G09G 2330/021; G09G 2360/10; G09G 2370/20; G09G 2370/22
USPC 345/520

(57) ABSTRACT

An automatically-configurable video system having multiple video sources. Upon system power-up, if an external video signal is present, it is automatically routed to a display. If it is not present, and if a graphics subsystem video signal is present, that signal is automatically routed to the display, and if the graphics subsystem video signal is also not present, a video signal from a primary video subsystem is routed to the display.

### BACKGROUND

Computer systems with built-in visual displays are becoming ubiquitous. Such computer systems are often realized in portable computers such as laptops. Different types of portable computers, and different software applications that run on those computers, offer an enormous variety of capabilities. Many computers now include more than one video system for generating video signals that drive the display. For example, some computers have a primary video system that provides a primary video signal and a separate graphics subsystem that provides its own video signal. The primary video system handles alpha-numeric characters and some graphics, and the separate graphics subsystem handles more advanced graphics. Depending on which function the computer is performing, the appropriate video signal is routed to the display. A computer with a built-in display often has a video output port that outputs a video signal. A separate display may be connected to such a port. For example, a user may desire a display that is physically larger, and therefore easier to read and capable of displaying more data and better graphics, than the built-in display. Video output ports and their associated circuitry typically comply with such standards as VGA, to output analog video signals, and DVI, to output digital video signals. The Video Electronics Standards Association has developed a digital video display interface known as DisplayPort. The current DisplayPort standard, version 1.2, became effective Dec. 22, 2009.

### BRIEF DESCRIPTION OF THE DRAWINGS

The drawings illustrate by example implementations of the invention.

FIG. 1 is a flowchart of a method of configuring a video system having multiple sources.

FIG. 2 is a block diagram of an automatically configurable video system with multiple sources.

FIG. 3 is a block diagram of a computer system that incorporates elements of an automatically configurable video system.

### DETAILED DESCRIPTION

In the drawings and in this description, examples and details are used to illustrate principles of the invention. Other configurations may suggest themselves. Parameters such as voltages, particular components, and component values are approximate. Some known methods and structures have not been described in detail in order to avoid obscuring the invention. Methods defined by the claims may comprise steps in addition to those listed, and except as indicated in the claims themselves the steps may be performed in another order than that given. Accordingly, the invention may be practiced without limitation to the details and arrangements as described. The invention is to be limited only by the claims, not by the drawings or this description.

A user of a computer system such as a laptop with a built-in display, more than one internal video source, and a video port, must deal with a variety of possible video configurations. There has been a need for a user-friendly way to manage these configurations.

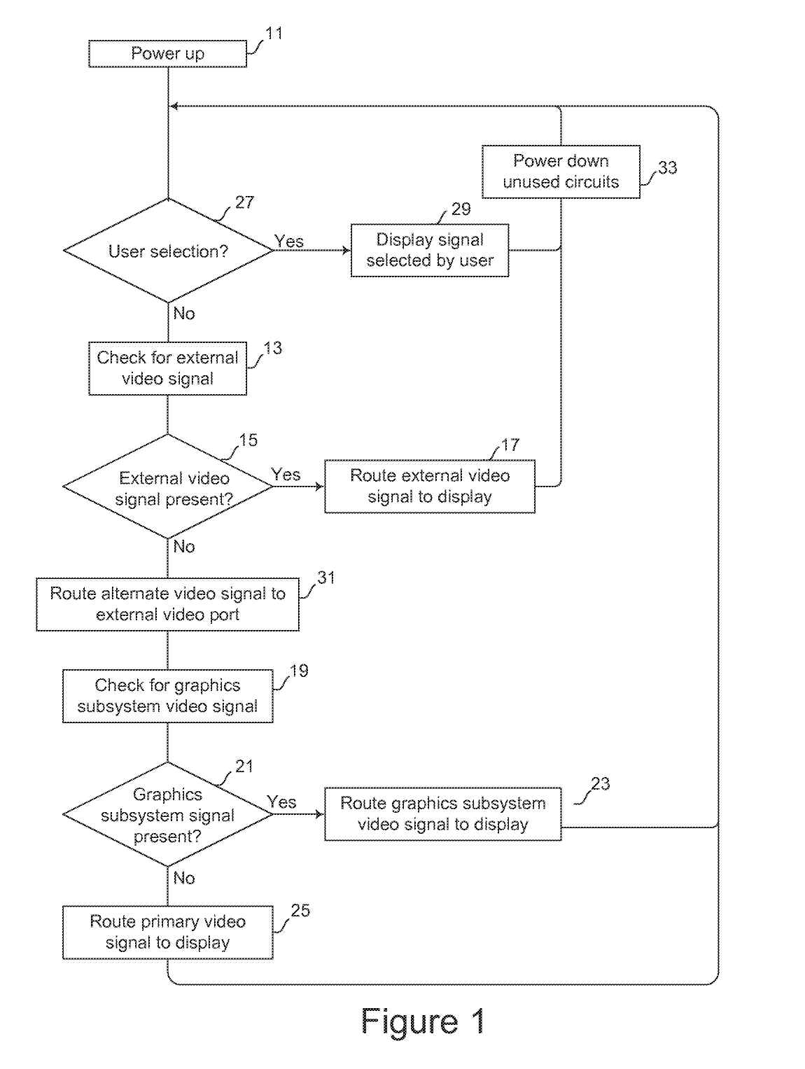

FIG. 1 shows a method of automatically configuring a video system having multiple video sources. The method begins, at system power-up (11), with automatically checking for an external video signal (13). If an external video signal is present (15), that signal is routed to a display (17), but if an external video signal is not present, the system automatically checks for a graphics subsystem video signal (19). If a graphics subsystem video signal is present (21) that graphics subsystem video signal is routed to the display (23), but if a graphics subsystem video signal is not present, the system automatically routes a video signal from a primary video subsystem to the display (25).

In the above method, the system first checks for an external video signal because it is likely that, if a user has connected an external video source, the user wants to use the display with that source. If the user has not connected an external source, it is likely that the user wants to display the video output signal from a graphics subsystem rather than the signal from the primary video subsystem if a graphic subsystem video signal is present. Some embodiments give the user the option of overriding these choices. These embodiments include checking for a user selection of a video signal for display (27), and if the user has selected a video signal, routing the selected video signal to the display (29). This gives the user the ability to manually override the automatic selections otherwise made by the system.

In some embodiments checking for a graphics subsystem video signal may mean simply checking whether a graphics subsystem is present. This reflects an assumption that if such a system is connected, it is providing a graphics subsystem video signal.

In some embodiments, if an external video signal is not present and a video signal from an internal source is being displayed, an alternate video signal from that internal source is routed to an external video port (31). The external video port is then ready if the user connects an external display. The alternate video signal is provided in suitable format for routing to an external display, for example VGA, DVI, or DisplayPort, and may be provided in more than one format through appropriate connectors as desired.

In some embodiments, if an external video signal is being routed to the display, unused circuits may be powered down (33), for example to save energy.

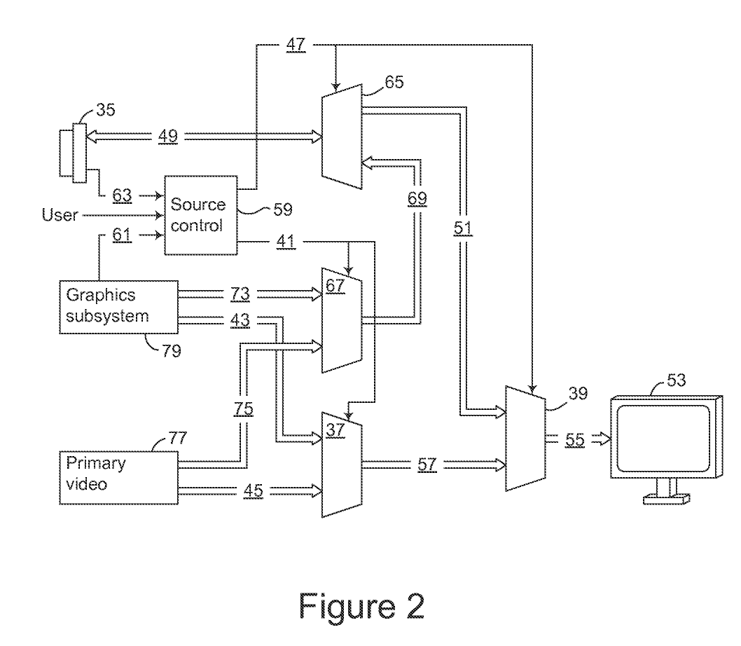

FIG. 2 shows an automatically configurable video subsystem with multiple video sources. The subsystem includes a video port 35, a first multiplexer 37, and a second multiplexer 39. The first multiplexer is responsive to a graphics-subsystem control signal on a line 41 to select a graphics-subsystem video signal on a line 43 when the graphics-subsystem control signal indicates presence of a graphics-subsystem video signal and otherwise to select a primary video signal on a line 45. The second multiplexer 39 is responsive to an external-video control signal on a line 47 to route an external video signal from the video port on a line 49 to a line 51 and on to a display 53 on a line 55 when the external-video control signal indicates presence of an external video signal at the video port and otherwise to route the selected video signal from the first multiplexer 37 on a line 57 to the display.

The external-video control signal may be provided by an external video source connected to the video port. For example, in the DisplayPort protocol, a voltage of 3 volts or more on an AUX connector pin in the DisplayPort indicates that an external video source is present. Conversely, the absence of such a voltage indicates that no external video source is present.

In some embodiments the first and second multiplexers are responsive to a video-selection command from a user to route the graphics-subsystem video signal, the primary video signal, or the external video signal to the display regardless of any indications of the graphics-subsystem control signal and the external-video control signal. This is indicated symbolically by a source control unit 59 that receives the graphics-subsystem control signal from the graphics subsystem (or from a sensor that senses connection of the graphics subsystem) on a line 61 and the external-video control signal from the video port on a line 63. In the absence of an overriding command from a user, the source control unit connects the external-video control signal on the line 63 to the line 47, and the graphics-subsystem control signal on the line 61 to the line 41. An override command from a user causes appropriate signals to be sent over the lines 47 and 41 to cause the video signal desired by the user to be routed to the display. In an actual embodiment the source control unit might be implemented by logic circuits or by machine instructions that control a computer system that includes the video subsystem.

In some embodiments a third multiplexer 65 is responsive to the external-video control signal to route an alternate video signal from a fourth multiplexer 67 as carried on a line 69 to the video port. In the embodiment shown, the alternate video signal is carried on the line 49 to the port 35, but in other embodiments a separate line and a separate video port might be used. The alternate signal may be provided in suitable format, as discussed above, and one or more connectors may be used as needed. The fourth multiplexer 67 is responsive to the graphics-subsystem control signal to select an alternate (external-output) graphics-subsystem video signal on a line 73 or an alternate primary video signal on a line 75 and provide the selected external-output video signal to the third multiplexer on the line 69. The primary video subsystem 77 and the graphics subsystem 79 each provide primary and alternate video signals , the primary one for the internal display being selected by the multiplexer 37 and the alternate one for the video port being selected by the multiplexer 67.

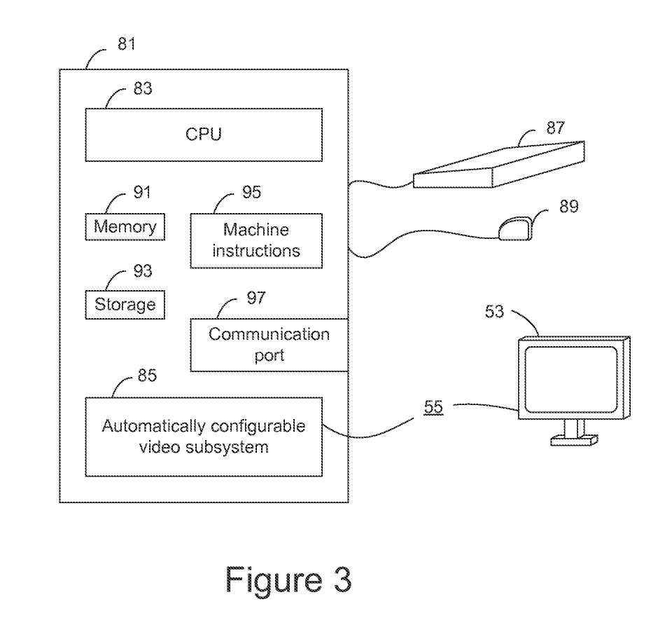

A computer system 81 with automatic video configuration for multiple video sources is shown in FIG. 3. The computer system includes a central processor 83, an automatically configurable video subsystem 85 similar to that discussed above, and a display 53 similar to the one discussed above. The computer system also may have one or more of input facilities such as a keyboard 87 and a mouse 89, memory 91, storage 93 such as a disk drive, machine instructions 95 which may be stored in the storage 93 or the memory 91, and a communication port 97. The primary video subsystem 77 is responsive to the central processor to provide a primary video signal and the graphics subsystem 79 is responsive to the central processor to provide a graphics-subsystem video signal.

In some embodiments the central processor is responsive to a video-selection command from a user to cause the first and second multiplexers to route the graphics-subsystem video signal, the primary video signal, or the external video signal to the display regardless of any indications of the graphics-subsystem control signal and the external-video control signal. This is the function that is indicated symbolically by the source control unit 59 in FIG. 2. This function may be implemented by the machine instructions and the user may provide the video-selection command using the input facilities and the display.

In some embodiments the machine instructions cause the central processor to power down unneeded circuits when the external video signal is being routed to the display.

Embodiments as discussed above provide a system that automatically configures itself to display the video signal most likely to be desired by a user while giving the user the option to change the configuration as desired. This allows for a more intuitive user experience whether or not the user knows any special key sequences and eliminates any need to boot any particular operating system or to run a specific application.

We claim:

1. A method of automatically configuring a video system having multiple video sources, the method comprising:
upon system power-up, automatically checking for an external video signal;
if an external video signal is present, routing that signal to a display;
if an external video signal is not present, automatically checking for a graphics subsystem video signal;
if a graphics subsystem video signal is present, routing that signal to the display; and
if a graphics subsystem video signal is not present, routing a video signal from a primary video subsystem to the display.

2. The method of claim 1 and further comprising checking for a user selection of a video signal for display and, if the user has selected a video signal, routing the selected video signal to the display.

3. The method of claim 1 wherein checking for a graphics subsystem video signal comprises checking whether a graphics subsystem is present.

4. The method of claim 1 and further comprising, when a video signal from an internal source is being routed to the display, routing an alternate video signal from that source to an external video port.

5. The method of claim 1 and further comprising, if an external video signal is being routed to the display, powering down unused circuits.

6. An automatically configurable video subsystem with multiple video sources, the subsystem comprising:
a video port;
a first multiplexer responsive to a graphics-subsystem control signal to select a graphics-subsystem video signal when the graphics-subsystem control signal indicates presence of a graphics-subsystem video signal and otherwise to select a primary video signal; and
a second multiplexer responsive to an external-video control signal to route an external video signal from the video port to a display when the external-video control signal indicates presence of an external video signal at the video port and otherwise to route the selected video signal from the first multiplexer to the display.

7. The subsystem of claim 6 wherein the first and second multiplexers are responsive to a video-selection command from a user to route the graphics-subsystem video signal, the primary video signal, or the external video signal to the display regardless of any indications of the graphics-subsystem control signal and the external-video control signal.

8. The subsystem of claim 6 wherein the graphics-subsystem control signal indicates presence of a graphics-subsystem video signal when a graphics subsystem circuit is connected to the first multiplexer.

9. The subsystem of claim 6 and further comprising a third multiplexer responsive to the external-video control signal to route an alternate video signal to the video port when the external-video control signal indicates absence of an external video signal at the video port.

10. The subsystem of claim 9 and further comprising a fourth multiplexer responsive to the graphics-subsystem control signal to select an alternate video signal from a graphics subsystem when the graphics-subsystem control signal indicates presence of a graphics-subsystem video signal and otherwise to select an alternate video signal from a primary video source and to provide the selected signal to the third multiplexer.

11. A computer system with automatic video configuration for multiple video sources, the system comprising:
a central processor;
a primary video subsystem responsive to the central processor to provide a primary video signal;
a graphics subsystem responsive to the central processor to provide a graphics-subsystem video signal;
a video port;
a display;
a first multiplexer responsive to a graphics-subsystem control signal from the graphics subsystem to select the graphics-subsystem video signal when the graphics-subsystem control signal indicates presence of the graphics-subsystem video signal and otherwise to select the primary video signal; and
a second multiplexer responsive to an external-video control signal at the video port to route an external video signal from the video port to the display when the external-video control signal indicates presence of an external video signal at the video port and otherwise to route the selected video signal from the first multiplexer to the display.

12. The system of claim 11 and further comprising a user input in communication with the central processor, and wherein the central processor is responsive to a video-selection command from a user to cause the first and second multiplexers to route the graphics-subsystem video signal, the primary video signal, or the external video signal to the display regardless of any indications of the graphics-subsystem control signal and the external-video control signal.

13. The system of claim 11 wherein the graphics-subsystem control signal indicates presence of a graphics-subsystem video signal when the graphics subsystem is physically present.

14. The system of claim 11 and further comprising a third multiplexer responsive to the external-video control signal to route an alternate video signal from the first multiplexer to the video port when the external-video control signal indicates absence of an external video signal at the video port.

15. The system of claim 11 and further comprising machine instructions that cause the central processor to power down unneeded circuits when the external video signal is being routed to the display.
